(19) United States
(12) Patent Application Publication
(10) Pub. No.: US 2006/0255777 A1
(43) Pub. Date: Nov. 16, 2006

(54) Apparatus and method for improving voltage converter low load efficiency

(76) Inventor: Henry W. Koertzen, Olympia, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/126,851

(22) Filed: May 10, 2005

(51) Int. Cl. G05F 1/00

(52) U.S. Cl. 323/272

(57) ABSTRACT

Some embodiments involve identifying a reduced load condition and disabling at least one switch circuit in an active phase of a voltage converter during the reduced load condition. Other embodiments are disclosed and claimed.

The invention relates to voltage converters and more particularly to an apparatus and method for improving voltage converter low load efficiency.

### BACKGROUND AND RELATED ART

Voltage converters and voltage regulators are well known in the art. U.S. Pat. No. 6,650,096 describes a multiple phase switching regulator circuit. U.S. Pat. No. 6,650,556 describes a multi-phase DC-DC converter. U.S. Patent Publication No. 2003/0090248 describes a power supply. U.S. Patent Publication No. 2004/0158449 describes a processor sensing voltage regulator.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a block diagram of a voltage converter circuit in accordance with some embodiments of the present invention.

FIG. 2 is another block diagram of a voltage converter circuit in accordance with some embodiments of the present invention.

FIG. 3 is another block diagram of a voltage converter circuit in accordance with some embodiments of the present invention.

FIG. 4 is another block diagram of a voltage converter circuit in accordance with some embodiments of the present invention.

FIG. 5 is a flow diagram in accordance with some embodiments of the present invention.

FIG. 6 is a schematic diagram of a voltage converter circuit in accordance with some embodiments of the present invention.

FIG. 7 is a graph of efficiency versus load current in accordance with some embodiments of the present invention.

FIG. 8 is a block diagram of a system in accordance with some embodiments of the present invention.

FIG. 9 is another block diagram of a system in accordance with some embodiments of the present invention.

FIG. 10 is a schematic diagram of another voltage converter circuit in accordance with some embodiments of the present invention.

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

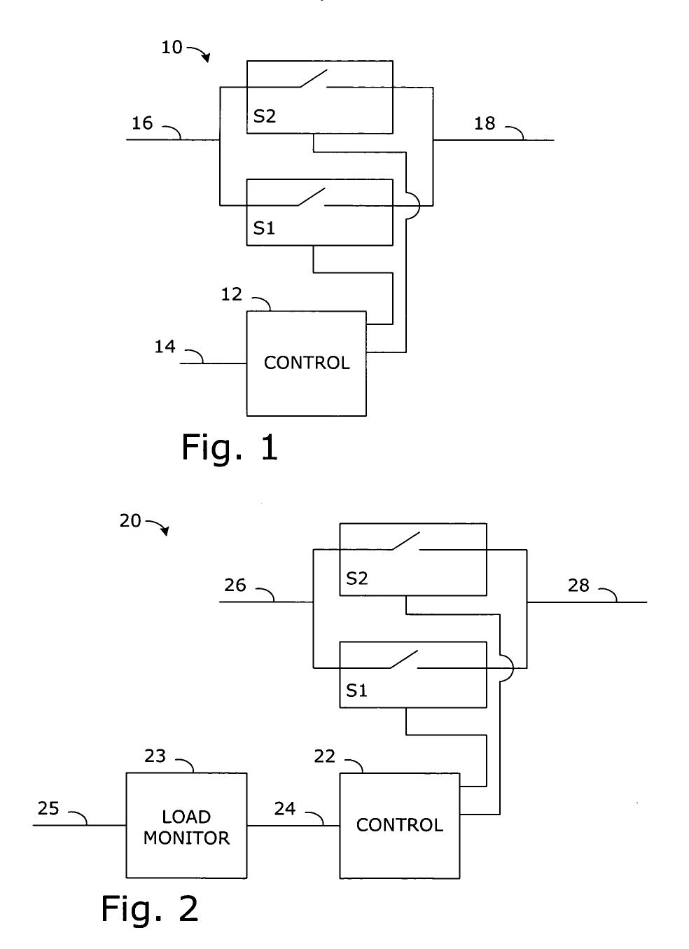

With reference to FIG. 1, a voltage converter 10 includes a plurality of switch circuits S1, S2 connected in parallel, and a control circuit 12 coupled to the plurality of parallel switch circuits S1, S2. The control circuit 12 may be configured to disable at least one of the plurality of parallel switch circuits S1, S2 in an active phase of the voltage converter 10 during a reduced load condition. For example, the control circuit 12 may be configured to receive a signal 14 which indicates the reduced load condition. For example, the signal 14 may correspond to a reduced activity state of a processor. Some embodiments may be multi-phase and some embodiments may be single phase (in which case the active phase is the only phase). For example, the voltage converter 10 continues to operate in the active phase during the reduced load condition with the at least one of the plurality of parallel switch circuits disabled.

The voltage converter 10 may receive an input signal 16 (e.g. a first DC voltage) on one side of the plurality of parallel switch circuits and provide an output signal 18 (e.g. a second DC voltage) on the other side of the plurality of parallel switch circuits. Various filter elements (not shown, e.g. inductors, capacitors and/or resistors) may be provided at the output 18 of the voltage converter 10. Advantageously, in some applications of the voltage converter 10, disabling at least one of the plurality of parallel switch circuits S1, S2 in an active phase of the voltage converter 10 during the reduced load condition may improve the voltage converter's low load efficiency.

With reference to FIG. 2, a voltage converter 20 includes a plurality of switch circuits S1, S2 connected in parallel, and a control circuit 22 coupled to the plurality of parallel switch circuits S1, S2. The control circuit 22 may be configured to disable at least one of the plurality of parallel switch circuits S1, S2 in an active phase of the voltage converter during a reduced load condition. For example, the control circuit 22 may be configured to receive a signal 24 which indicates the reduced load condition. For example, the signal 24 may be provided by a load monitor circuit 23.

For example, the monitor circuit 23 may be configured to monitor a load condition, compare the monitored load condition against a threshold, and provide the signal 24 which indicates the reduced load condition when the monitored load condition is less than the threshold. The monitor circuit 23 may receive a signal 25 from the load. For example, the monitor circuit may include a comparator which receives the signal 25 at one input and has the other input tied to a threshold value. Appropriately configured, the output of the comparator may be provided as the signal 24.

The voltage converter 20 may receive an input signal 26 (e.g. a first DC voltage) on one side of the plurality of parallel switch circuits and provide an output signal 28 (e.g. a second DC voltage) on the other side of the plurality of parallel switch circuits. Advantageously, in some applications of the voltage converter 20, disabling at least one of the plurality of parallel switch circuits S1, S2 in an active phase of the voltage converter 20 during the reduced load condition may improve the voltage converter's low load efficiency.

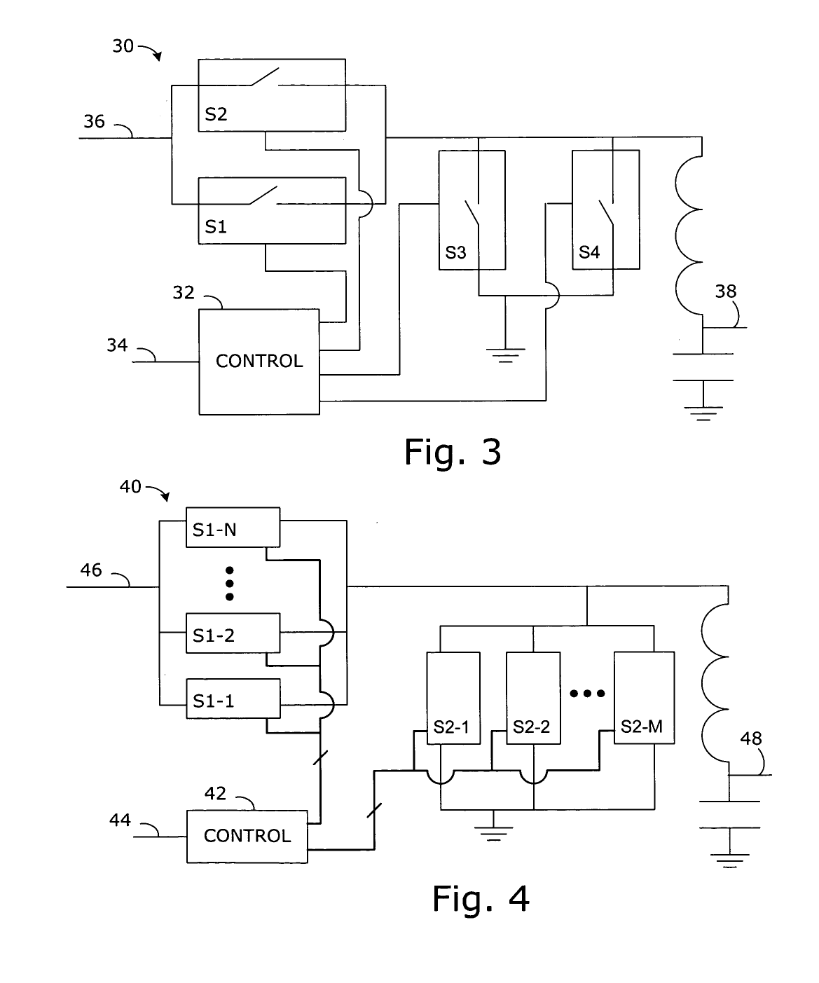

With reference to FIG. 3, a voltage converter 30 includes a first plurality of switch circuits S1, S2 connected in parallel, and a control circuit 32 coupled to the first plurality of parallel switch circuits S1, S2. The control circuit 32 may be configured to disable at least one of the first plurality of parallel switch circuits S1, S2 in an active phase of the voltage converter during a reduced load condition. For example, the control circuit 32 may be configured to receive a signal 34 which indicates the reduced load condition. For example, the signal 34 may correspond to a reduced activity state of a processor or may be provided by a load monitor circuit.

The voltage converter 30 may receive an input signal 36 (e.g. a first DC voltage) on one side of the first plurality of parallel switch circuits S1, S2. The voltage converter 30 further includes a second plurality of switch circuits S3, S4 connected in parallel. One side of the second plurality of parallel switch circuits S3, S4 may be connected to a second side the first plurality of parallel switch circuits S1, S2 and a second side of the second plurality of parallel switch circuits S3, S4 may be connected to ground. An LC circuit (e.g. including an inductor in series with a capacitor) may be connected between a junction of the first and second plurality of parallel switch circuits and ground, where a junction between the inductor and the capacitor in the LC circuit provides an output signal 38 (e.g. a second DC voltage) for the voltage converter 30.

In some embodiments of the invention, the control circuit 32 may be configured to disable at least one switch circuit in each of the first and second plurality of parallel switch circuits (e.g. switch circuits S1 and S3) during the reduced load condition. Advantageously, in some applications of the voltage converter 30, disabling at least one switch circuit in each of the first and second plurality of parallel switch circuits during the reduced load condition may improve the voltage converter's low load efficiency.

With reference to FIG. 4, a voltage converter 40 includes a first plurality of N switch circuits S1-1, S1-2 through S1-N connected in parallel, and a control circuit 42 coupled to the first plurality of N parallel switch circuits. The control circuit 42 may be configured to disable at least one of the first plurality of N parallel switch circuits in an active phase of the voltage converter during a reduced load condition. For example, the control circuit 42 may be configured to receive a signal 44 which indicates the reduced load condition. For example, the signal 44 may correspond to a reduced activity state of a processor or may be provided by a load monitor circuit.

The voltage converter 40 may receive an input signal 46 (e.g. a first DC voltage) on one side of the first plurality of N parallel switch circuits. The voltage converter 40 further includes a second plurality of M switch circuits S2-1, S2-2 through S2-M connected in parallel. For example, the number of switch circuits may be the same (e.g. N=M) or may be different. One side of the second plurality of M parallel switch circuits may be connected to a second side the first plurality of N parallel switch circuits and a second side of the second plurality of M parallel switch circuits may be connected to ground. An LC circuit (e.g. including an inductor in series with a capacitor) may be connected between a junction of the first and second plurality of parallel switch circuits and ground, where a junction between the inductor and the capacitor in the LC circuit provides an output signal 48 (e.g. a second DC voltage) for the voltage converter 40. For some applications of the voltage converter 40, the number of switch circuits N and M may be on the order of 4 to 8. Providing a higher number of switch circuits may provide better resolution. For an Integrated Silicon Voltage Regulator (ISVR) application, the number of switch circuits N and M may be on the order of tens, hundreds, or even thousands of switch circuits.

In some embodiments of the invention, the control circuit 42 may be configured to disable at least one switch circuit (e.g. switch circuits S1-1 and S2-1) in each of the first and second plurality of parallel switch circuits during the reduced load condition. In some embodiments, the reduced load condition may include two or more respective reduced load conditions (e.g. 50% load and 25% load). The control circuit 42 may be configured to disable an increasing number of parallel switch circuits in the active phase of the voltage converter in accordance with each respective reduced load condition. For example, under a 50% load condition, the control circuit 42 may disable switch circuits S1-1 and S2-1. Under a 25% load condition, the control circuit 42 may disable switch circuits S1-1, S1-2, S2-1, and S2-2. Advantageously, in some applications of the voltage converter 40, disabling an increasing number of switch circuits in the active phase of the voltage converter in accordance with each respective reduced load condition may improve the voltage converter's low load efficiency.

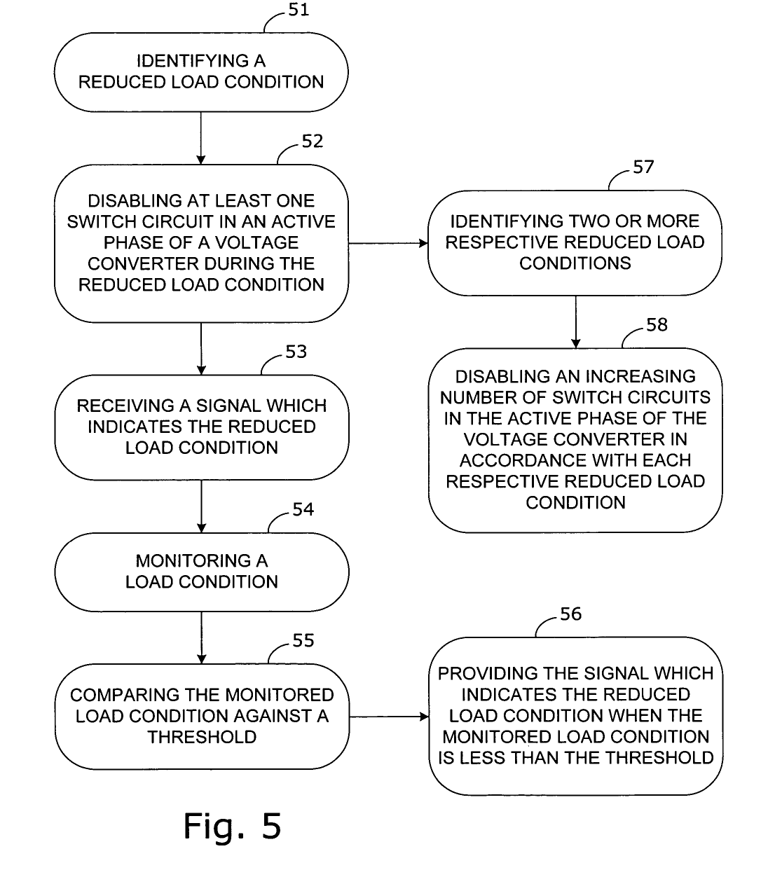

With reference to FIG. 5, some embodiments of the invention involve identifying a reduced load condition (e.g. at 51) and disabling at least one switch circuit in an active phase of a voltage converter during the reduced load condition (e.g. at 52). In some embodiments, identifying the reduced load condition may include receiving a signal which indicates the reduced load condition (e.g. at 53). For example, the signal may correspond to a reduced activity state of a processor.

Some embodiments of the invention may further involve monitoring a load condition (e.g. at 54), comparing the monitored load condition against a threshold (e.g. at 55), and providing the signal which indicates the reduced load condition when the monitored load condition is less than the threshold (e.g. at 56). In some embodiments, identifying the reduced load condition may include identifying two or more respective reduced load conditions (e.g. at 57), and disabling at least one switch circuit may include disabling an increasing number of switch circuits in the active phase of the voltage converter in accordance with each respective reduced load condition (e.g. at 58).

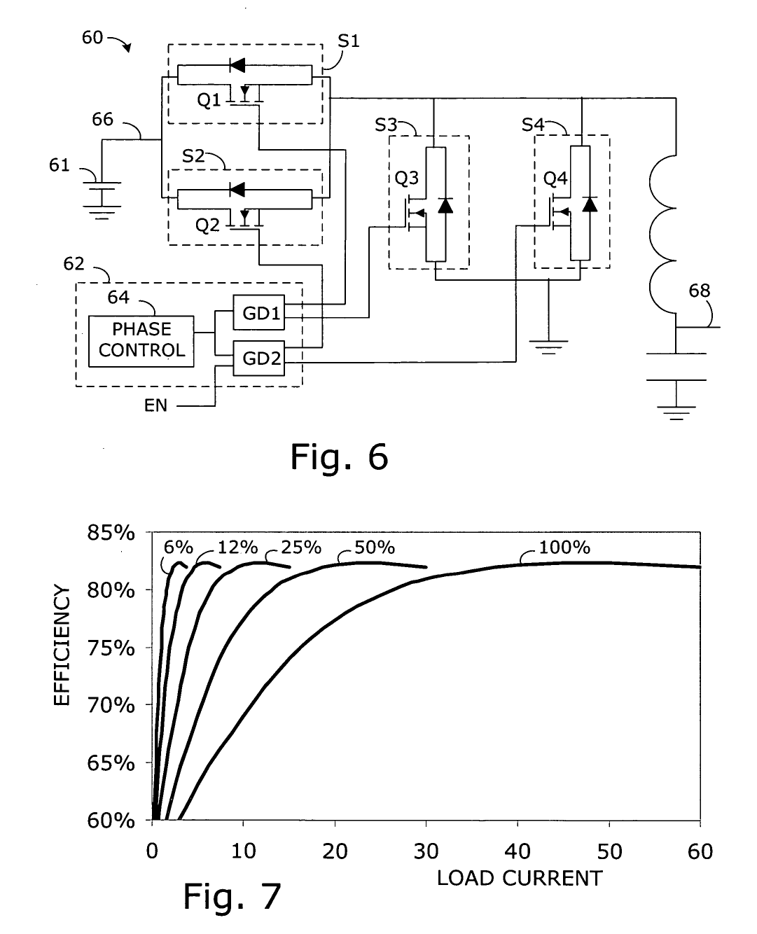

With reference to FIG. 6, one phase 60 of a single phase or multi-phase buck converter includes a first plurality of switch circuits S1, S2 connected in parallel, and a control circuit 62, including a phase control circuit 64 and a pair of gate driver circuits GD1 and GD2, coupled to the first plurality of parallel switch circuits S1, S2. The switch circuit S1 includes a power MOSFET Q1 having a gate, a source, and a drain (and illustrated together with its parasitic diode, also referred to as a body diode). The switch circuit S2 includes a power MOSFET Q2 having a gate, a source, and a drain.

The phase control circuit 64 provides a control signal to the gate drivers GD1 and GD2 which in turn are coupled to the switch circuits S1 and S2. The gate drive GD1 provides a gate drive signal to the gate of Q1. The gate drive circuit GD2 provides a gate drive signal to the gate of Q2. For example, the phase control circuit 64 may provide the phase control signals typical of a multi-phase buck converter.

The control circuit 62 may be further configured to disable at least one of the first plurality of parallel switch circuits S1, S2 in an active phase of the voltage converter during a reduced load condition. For example, the control circuit 62 may be configured to receive a signal EN which indicates the reduced load condition. For example, the signal EN may correspond to a reduced activity state of a processor or may be provided by a load monitor circuit.

For example, the signal EN may be coupled to an enable pin of the gate driver GD2. When the gate driver GD2 is enabled, the phase control circuit 64 controls the state of the signal provided to the switch circuit S2 via the gate driver GD2. However, during the reduced load condition the state of the EN signal may be changed such that the gate driver GD2 is disabled. When the gate driver GD2 is disabled, the switch circuit S2 is likewise disabled regardless of the phase control signals provided by the phase control circuit 64.

The switch circuits S1 and S2 may have similar operating characteristics or they may have significantly different operating characteristics. In some embodiments, the switch circuit S2 may include a large die FET Q2 (e.g. providing over seventy five percent of the rated power for the voltage converter 60) while the parallel switch circuit S1 may include a small die FET Q1. For example, the control circuit 62 may disable the large FET Q2 during low load operation. The switch circuits S1 and S2 and/or the FETs Q1 and Q2 may be co-packaged or may be packaged separately.

The voltage converter 60 may receive an input signal 66 (e.g. a first DC voltage) on one side of the first plurality of parallel switch circuits S1, S2. For example, the voltage converter 60 may be coupled to a DC power source 61 such as a battery or an AC/DC power supply. The voltage converter 60 further includes a second plurality of switch circuits S3, S4 connected in parallel. The switch circuit S3 includes a power MOSFET Q3 having a gate, a source, and a drain. The switch circuit S4 includes a power MOSFET Q4 having a gate, a source, and a drain.

One side of the second plurality of parallel switch circuits S3, S4 may be connected to a second side the first plurality of parallel switch circuits S1, S2 and a second side of the second plurality of parallel switch circuits S3, S4 may be connected to ground. The gate driver GD1 may provide a signal to the gate of Q3 and the gate driver GD2 may provide a signal to the gate of Q4. An LC circuit (e.g. including an inductor in series with a capacitor) may be connected between a junction of the first and second plurality of parallel switch circuits and ground, where a junction between the inductor and the capacitor in the LC circuit provides an output signal 68 (e.g. a second DC voltage) for the voltage converter 60.

In some embodiments of the invention, the control circuit 62 may be configured to disable at least one switch circuit in each of the first and second plurality of parallel switch circuits (e.g. switch circuits S2 and S4) during the reduced load condition. For example, when the gate driver GD2 is disabled by the signal EN, the switch circuits S2 and S4 are likewise disabled regardless of the phase control signals provided by the phase control circuit 64. Advantageously, in some applications of the voltage converter 60, disabling at least one switch circuit in each of the first and second plurality of parallel switch circuits during the reduced load condition may improve the voltage converter's low load efficiency.

For example, some embodiments of the invention may address the power conversion efficiency of a CPU voltage regulator (VR) at low load. The multi-phase buck converter topology is a commonly used topology. Power MOSFETs may be connected in parallel in each phase to obtain a desired current rating, and to distribute the heat generated by the devices. In a conventional multi-phase buck converter, all the power MOSFETs in the active phase are on, potentially causing poor conversion efficiency at low load. By selectively disabling (e.g. turning off) one or more power MOSFETs in the active phase of a multi-phase buck converter, some embodiments of the invention may improve the low load conversion efficiency, thereby reducing power consumption and heat generation during relatively inactive periods of operation.

Generally speaking, the conversion efficiency is not a constant, but rather is a function of the load. With reference to FIG. 7, a graph shows representative load current versus efficiency for varying percentages of active FETs in the voltage converter circuit (e.g. 100%, 50%, 25%, 12%, and 6% of FETs turned on). Referring to the 100% active curve, there is a load current where the efficiency peaks (e.g. at about 40-50 A), which may be less than the full load current for that curve. Above this load point the efficiency may decrease slightly, for example, due to conduction power losses becoming dominant. Below this load current, for example, the capacitive power loss may become dominant, and cause the efficiency to decrease. In conventional voltage converters, at low load the conversion efficiency can be very low. For example, the low efficiency may be due to the gate drive power loss being a constant. In some applications, a processor-based system may spend a significant amount of time in the low load state, which may lead to unnecessary power consumption because of the low conversion efficiency of conventional voltage converters at low loads.

Some embodiments of the invention may improve the low load efficiency of the voltage regulator by disabling some of the power MOSFETs in one or more phases (e.g. in each phase) when the CPU is in the low load state. For example, as described above in connection with FIG. 6, there are two control and two synchronous power MOSFETs per phase (only one VR phase is shown). The enable signal (EN) may disable the gate drive IC (e.g. GD2) for one MOSFET in each of the two MOSFET pairs. This may cause the voltage regulator to operate at higher efficiency under a low load condition, as shown in FIG. 7. For example, if the signal EN is asserted when the load current drops below a threshold of 25 A, half of the active FETs may be disabled. Referring to the 50% active curve, for a load current of about 20 A the efficiency may be better than 80%, as opposed to about 75% from 100% active curve. At even lower load conditions, the efficiency improvement may be much greater.

Advantageously, there may be little or no impact on the ripple voltage, stability or gate drive signals of the circuit, as may be the case if a whole VR phase is disabled. When the load current exceeds another threshold (e.g. 25A again or a slightly higher threshold to avoid excessive dither), the signal EN may be de-asserted such that all of the FETs again become active to provide sufficient power for the more demanding load conditions. In some embodiments, it may be desirable to keep all phases running with a reduced number of active switch circuits, instead of disabling one or more whole phases.

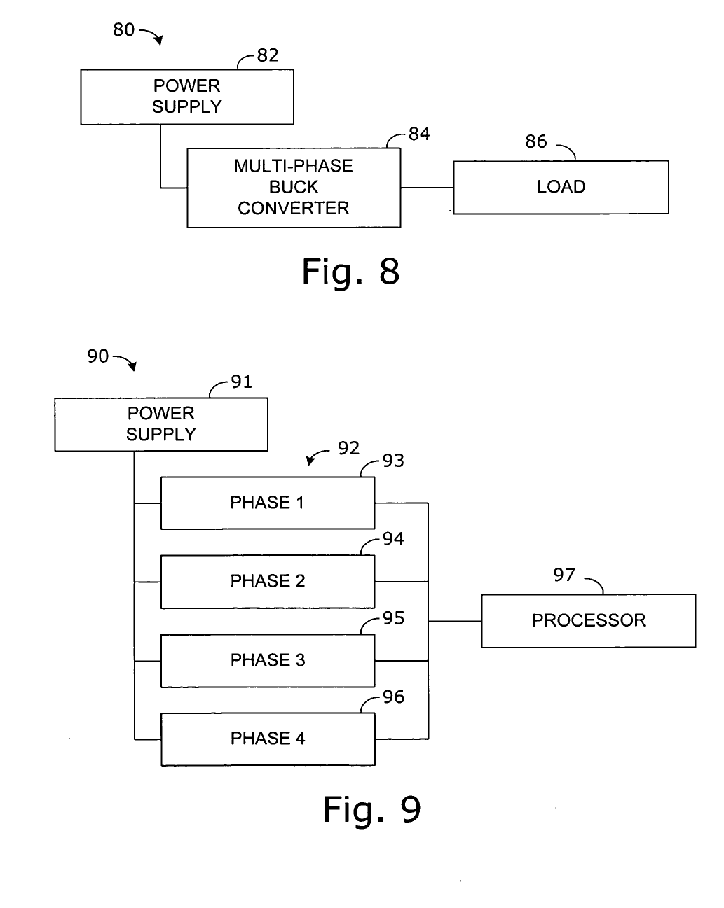

With reference to FIG. 8, a system 80 includes a power supply 82, a load 86, and a multi-phase buck converter 84 coupled between the power supply and the load, wherein the multi-phase buck converter 84 comprises one or more of the circuit structures described above in connection with FIGS. 1-7. For example, the multi-phase buck converter 84 may include a plurality of switch circuits connected in parallel and a control circuit coupled to the plurality of parallel switch circuits, wherein the control circuit is configured to disable at least one of the plurality of parallel switch circuits during a reduced load condition. In some embodiments, the control circuit may be configured to receive a signal which indicates the reduced load condition. For example, the signal may correspond to a reduced activity state of a processor.

In some embodiments, the system 80 may further include a monitor circuit configured to monitor a load condition, compare the monitored load condition against a threshold, and provide the signal which indicates the reduced load condition when the monitored load condition is less than the threshold.

In some embodiments of the system 80, the reduced load condition may include two or more respective reduced load conditions (e.g. 50% load and 25% load), and the control circuit may be configured to disable an increasing number of parallel switch circuits of the active phase of the voltage converter in accordance with each respective reduced load condition.

In some embodiments of the system 80, the plurality of parallel switch circuits may correspond to a first plurality of parallel switch circuits, and the multi-phase buck converter 84 may further include an input signal connected to one side of the first plurality of parallel switch circuits, a second plurality of switch circuit connected in parallel, with one side of the second plurality of parallel switch circuits connected to a second side the first plurality of parallel switch circuits and a second side of the second plurality of parallel switch circuits connected to ground, and an inductor connected between a junction of the first and second plurality of parallel switch circuits and ground. In some embodiments of the system 80, the control circuit in the multi-phase buck converter 84 may be configured to disable at least one switch circuit in each of the first and second plurality of parallel switch circuits during the reduced load condition.

With respect to FIG. 9, a system 90 includes a power supply 91, a processor 97, and a multi-phase buck converter 92 having four phases 93, 94, 95, and 96 coupled between the power supply 91 and the processor 97. Some embodiments of the invention may utilize more or less phases. Any and preferably all of the four phases 92-95 may include one or more of the circuit structures described above in connection with FIGS. 1-7. For example, each of phases 93-96 may include a plurality of switch circuits connected in parallel and a control circuit coupled to the plurality of parallel switch circuits, wherein the control circuit is configured to disable at least one of the plurality of parallel switch circuits during a reduced load condition. In some embodiments, the control circuit may be configured to receive a signal which indicates the reduced load condition. For example, the signal may be provided from the processor 96 and may indicate an activity state of the processor 97.

According to some embodiments of the invention, the system 90 may keep all four phases 93-96 active, but may only use a limited number of parallel FET circuits per phase to provide sufficient power for the existing load condition. By selectively disabling parallel FET circuits in each phase 93-96, capacitive power loss may be reduced or minimized at low load with little or no impact to electrical performance. Advantageously, some embodiments of the invention may provide substantially instantaneous return to full load capability.

For example, the processor 97 may have a state C0 indicating that the core is active (e.g. up to 100% Pmax), a state C3 indicating that the core is inactive with all data retained (e.g. about 1% of Pmax), and a state C6 indicating that the core is off with data stored retained (e.g. about 0.1% of Pmax), among other states for the processor 97. When the processor 97 switches states from C0 to, for example, C3, the processor 97 may send a signal to the converter 92 to enter a first reduced activity state. If the processor 97 switches states from C3 to, for example, C6, the processor 97 may send another signal to the converter 92 to enter a second reduced activity state. Advantageously, because the converter 92 maintains high efficiency at low loads, the reduced power benefits of the reduced activity C-states are improved.

When the processor 97 resumes operation, the processor 97 may send a signal to the converter 92 to exit the reduced activity state and enter an increased activity state, including full activity. For example, the converter 92 may be constructed from discrete components or manufactured as an integrated circuit on a single die. The converter 92 may be co-packaged with the processor 97 or may be integrated on a same die as the processor 97. A multi-core processor 97 may include one converter 92 per core. Alternatively, one converter 92 may provide power to multiple cores, with the number of active MOSFETs being adjusted in accordance with the load.

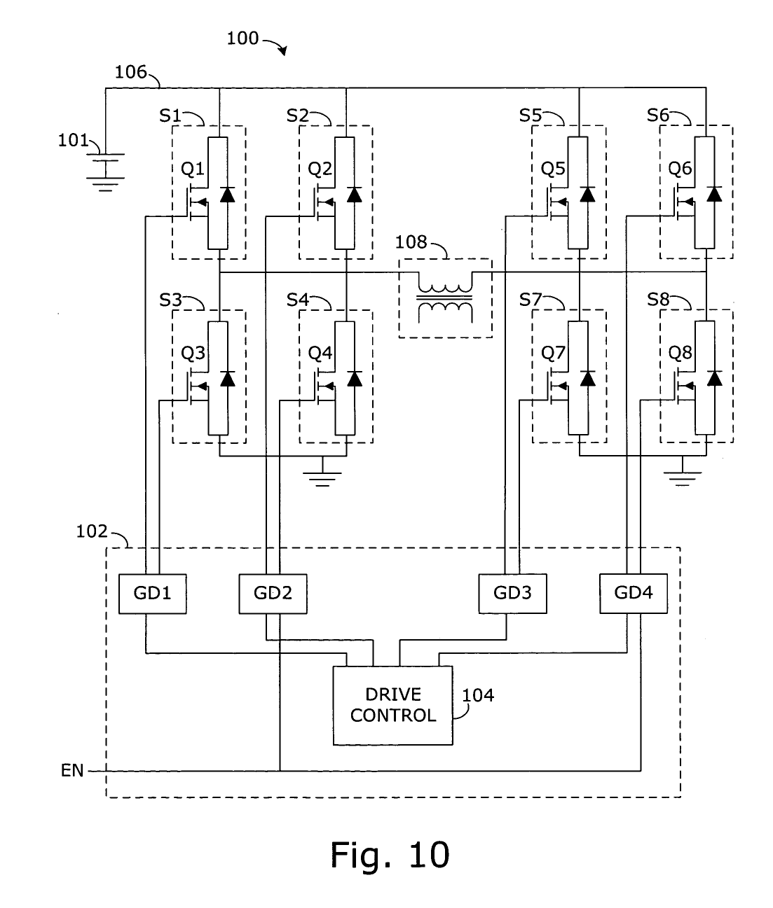

With respect to FIG. 10, a single phase full bridge converter 100 includes a first plurality of switch circuits S1, S2 connected in parallel, and a control circuit 102, including a phase control circuit 104 and a pair of gate driver circuits GD1 and GD2, coupled to the first plurality of parallel switch circuits S1, S2. The switch circuit S1 includes a power MOSFET Q1 having a gate, a source, and a drain (and illustrated together with its parasitic diode, also referred to as a body diode). The switch circuit S2 includes a power MOSFET Q2 having a gate, a source, and a drain.

The drive control circuit 104 provides a control signal to the gate drivers GD1 and GD2 which in turn are coupled to the switch circuits S1 and S2. The gate drive GD1 provides a gate drive signal to the gate of Q1. The gate drive circuit GD2 provides a gate drive signal to the gate of Q2. For example, the drive control circuit 104 may provide the drive control signals typical of a full bridge converter.

The control circuit 102 may be further configured to disable at least one of the first plurality of parallel switch circuits S1, S2 in an active phase (e.g. the only phase) of the voltage converter during a reduced load condition. For example, the control circuit 62 may be configured to receive a signal EN which indicates the reduced load condition. For example, the signal EN may correspond to a reduced activity state of a processor or may be provided by a load monitor circuit.

For example, the signal EN may be coupled to an enable pin of the gate driver GD2. When the gate driver GD2 is enabled, the drive control circuit 104 controls the state of the signal provided to the switch circuit S2 via the gate driver GD2. However, during the reduced load condition the state of the EN signal may be changed such that the gate driver GD2 is disabled. When the gate driver GD2 is disabled, the switch circuit S2 is likewise disabled regardless of the phase control signals provided by the drive control circuit 104.

The voltage converter 100 may receive an input signal 106 (e.g. a first DC voltage) on one side of the first plurality of parallel switch circuits S1, S2. For example, the voltage converter 100 may be coupled to a DC power source 101 such as a battery or an AC/DC power supply. The voltage converter 100 further includes a second plurality of switch circuits S3, S4 connected in parallel. The switch circuit S3 includes a power MOSFET Q3 having a gate, a source, and a drain. The switch circuit S4 includes a power MOSFET Q4 having a gate, a source, and a drain.

One side of the second plurality of parallel switch circuits S3, S4 may be connected to a second side the first plurality of parallel switch circuits S1, S2 and a second side of the second plurality of parallel switch circuits S3, S4 may be connected to ground. The gate driver GD1 may provide a signal to the gate of Q3 and the gate driver GD2 may provide a signal to the gate of Q4. A junction of the first and second plurality of parallel switch circuits may provide an output signal to one side of an output circuit 108 (e.g. a rectifier, filter, and load circuit) for the voltage converter 100.

The other half of the full bridge converter circuit includes a third plurality of parallel switch circuits S5, S6 and a fourth plurality of parallel switch circuit S7, S8, each including respective power MOSFETs Q5, Q6, Q7, and Q8. The other half of the circuit may be connected similarly and operate similarly as described in connection with switch circuits S1, S2, S3, and S4. Switch circuits S5 and S7 may be connected to a gate driver circuit GD3. Switch circuits S6 and S8 may be connected to a gate driver circuit GD4. The signal EN may be coupled to an enable pin of the gate driver GD4, to selectively disable switch circuits S6 and S8 in an active phase of the voltage converter 100 during a reduced load condition. A junction of the third and fourth plurality of parallel switch circuits may provide an output signal to the other side of the output circuit 108 for the voltage converter 100.

In some embodiments of the invention, the control circuit 102 may be configured to disable at least one switch circuit in each of the first, second, third and fourth plurality of parallel switch circuits (e.g. switch circuits S2, S4, S6, and S8) during the reduced load condition. For example, when the gate drivers GD2 and GD4 are disabled by the signal EN, the switch circuits S2, S4, S6 and S8 are likewise disabled regardless of the phase control signals provided by the drive control circuit 104. Advantageously, in some applications of the voltage converter 100, disabling at least one switch circuit in each of the first, second, third and fourth plurality of parallel switch circuits during the reduced load condition may improve the voltage converter's low load efficiency.

For example, some embodiments of the invention may address the power conversion efficiency of a CPU voltage regulator (VR) at low load. The full-bridge converter topology is a commonly used topology. Power MOSFETs may be connected in parallel in each phase to obtain a desired current rating, and to distribute the heat generated by the devices. In a conventional full bridge converter, all the power MOSFETs in the active phase are on, potentially causing poor conversion efficiency at low load. By selectively disabling (e.g. turning off) one or more power MOSFETs in the active phase of a full bridge converter, some embodiments of the invention may improve the low load conversion efficiency, thereby reducing power consumption and heat generation during relatively inactive periods of operation.

Although described in detail in connection with a voltage converter for a processor, the invention is not limited to this application. For example, some embodiments of the invention may be applied to the main power supply of a personal computer system or other electrical system. Although described with specific examples of buck converters and full bridge converters, those skilled in the art will recognize that some embodiments of the present invention may find utility in other voltage converter topologies including, for example, half bridge converters, push pull converters, forward converters, etc. In some applications, the size of the inductor in the converter circuit may impact how well the circuit works. For example, in theory a constant conversion efficiency may be obtained if there is an infinite number of phases and no inductor current ripple (infinitely large inductance). However, practical circuits may have some inductor current ripple which may reduce the maximum benefit provided by some embodiments of the invention.

The foregoing and other aspects of the invention are achieved individually and in combination. The invention should not be construed as requiring two or more of such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

What is claimed is:

1. A method, comprising:
identifying a reduced load condition; and
disabling at least one switch circuit in an active phase of a voltage converter during the reduced load condition.

2. The method of claim 1, wherein identifying the reduced load condition includes:
receiving a signal which indicates the reduced load condition.

3. The method of claim 2, wherein the signal corresponds to a reduced activity state of a processor.

4. The method of claim 2, further comprising:
monitoring a load condition;
comparing the monitored load condition against a threshold; and
providing the signal which indicates the reduced load condition when the monitored load condition is less than the threshold.

5. The method of claim 1, wherein identifying the reduced load condition includes identifying two or more respective reduced load conditions, and wherein disabling at least one switch circuit includes disabling an increasing number of switch circuits in the active phase of the voltage converter in accordance with each respective reduced load condition.

6. A voltage converter, comprising:
a plurality of switch circuits connected in parallel; and
a control circuit coupled to the plurality of parallel switch circuits, wherein the control circuit is configured to disable at least one of the plurality of parallel switch circuits in an active phase of the voltage converter during a reduced load condition.

7. The voltage converter of claim 6, wherein the control circuit is configured to receive a signal which indicates the reduced load condition.

8. The voltage converter of claim 7, wherein the signal corresponds to a reduced activity state of a processor.

9. The voltage converter of claim 7, further comprising:
a monitor circuit configured to:
monitor a load condition;
compare the monitored load condition against a threshold; and
provide the signal which indicates the reduced load condition when the monitored load condition is less than the threshold.

10. The voltage converter of claim 6, wherein the plurality of parallel switch circuits corresponds to a first plurality of parallel switch circuits, the apparatus further comprising:
an input signal connected to one side of the first plurality of parallel switch circuits;
a second plurality of switch circuits connected in parallel, with one side of the second plurality of parallel switch circuits connected to a second side the first plurality of parallel switch circuits and a second side of the second plurality of parallel switch circuits connected to ground; and
an LC circuit connected between a junction of the first and second plurality of parallel switch circuits and ground.

11. The voltage converter of claim 10, wherein the control circuit is configured to disable at least one switch circuit in each of the first and second plurality of parallel switch circuits during the reduced load condition.

12. The voltage converter of claim 6, wherein the reduced load condition includes two or more respective reduced load conditions, and wherein the control circuit is configured to disable an increasing number of parallel switch circuits in the active phase of the voltage converter in accordance with each respective reduced load condition.

13. The voltage converter of claim 6, wherein a first switch circuit of the plurality of parallel switch circuits has different operating characteristics as compared to a second of the plurality of parallel switch circuits.

14. The voltage converter of claim 13, wherein the first switch circuit provides over seventy five percent of the rated power for the voltage converter.

15. A system, comprising:
a power supply;
a load; and
a voltage converter coupled between the power supply and the load, wherein the voltage converter comprises:
a plurality of switch circuits connected in parallel; and
a control circuit coupled to the plurality of parallel switch circuits, wherein the control circuit is configured to disable at least one of the plurality of parallel switch circuits in an active phase of the voltage converter during a reduced load condition.

16. The system of claim 15, wherein the control circuit is configured to receive a signal which indicates the reduced load condition.

17. The system of claim 16, wherein the signal corresponds to a reduced activity state of a processor.

18. The system of claim 16, further comprising:
a monitor circuit configured to:
monitor a load condition;
compare the monitored load condition against a threshold; and
provide the signal which indicates the reduced load condition when the monitored load condition is less than the threshold.

19. The system of claim 15, wherein the reduced load condition includes two or more respective reduced load conditions, and wherein the control circuit is configured to disable an increasing number of parallel switch circuits in the active phase of the voltage converter in accordance with each respective reduced load condition.

20. The system of claim 15, wherein the plurality of parallel switch circuits corresponds to a first plurality of parallel switch circuits, the apparatus further comprising:
an input signal connected to one side of the first plurality of parallel switch circuits;
a second plurality of switch circuit connected in parallel, with one side of the second plurality of parallel switch circuits connected to a second side the first plurality of parallel switch circuits and a second side of the second plurality of parallel switch circuits connected to ground; and
an LC circuit connected between a junction of the first and second plurality of parallel switch circuits and ground.

21. The system of claim 20, wherein the control circuit is configured to disable at least one switch circuit in each of the first and second plurality of parallel switch circuits during the reduced load condition.
